(19) United States
(12) Patent Application Publication
(10) Pub. No.: US 2013/0346920 A1
(43) Pub. Date: Dec. 26, 2013

(54) MULTI-SENSORIAL EMOTIONAL EXPRESSION

(71) Applicants: Margaret E. Morris, Portland, OR (US); Douglas M. Carmean, Hillsboro, OR (US)

(72) Inventors: Margaret E. Morris, Portland, OR (US); Douglas M. Carmean, Hillsboro, OR (US)

(21) Appl. No.: 13/687,846

(22) Filed: Nov. 28, 2012

Related U.S. Application Data
(60) Provisional application No. 61/662,132, filed on Jun. 20, 2012.

(51) Int. Cl. G06F 3/0482

(52) U.S. Cl. CPC G06F 3/0482
USPC 715/835

(57) ABSTRACT

Storage medium, method and apparatus associated with multi-sensorial expression of emotion to photos/pictures are disclosed herein. In embodiments, at least one storage medium may include a number of instructions configured to enable a computing device, in response to execution of the instructions by the computing device, to display a number of images having associated emotion classifications on a display device accessible to a number of users, and facilitate the number of users to individually and/or jointly modify the emotion classifications of the images in a multi-sensorial manner. Other embodiments may be disclosed or claimed.

### RELATED APPLICATION

This application is a non-provisional application of provisional application 61/662,132, and claims priority to the 61/662,132 provisional application. The specification of the 61/662,132 provisional application is hereby incorporated by reference.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of an arrangement associated with multi-sensorial emotional expression on a touch sensitive display screen;

FIG. 2 illustrates a method associated with multi-sensorial emotional expression on a touch sensitive display screen;

FIG. 3 illustrates an example computer suitable for use for the arrangement of FIG. 1; and

FIG. 4 illustrates an example non-transitory computer-readable storage medium having instructions configured to practice all or selected aspects of the method of FIG. 2; all arranged in accordance with embodiments of the present disclosure.

### DETAILED DESCRIPTION

Methods, apparatuses and storage medium associated with multi-sensorial emotional expression are disclosed herewith. In various embodiments, a large display screen may be provided to display images with associated emotion classifications. The images may, e.g., be photos uploaded to Instagram or other social media by participants/viewers, analyzed and assigned the associated emotion classifications. Analysis and assignment of the emotion classifications may be made based on, e.g., sentimental analysis or matching techniques.

The large display screen may be touch sensitive. Individuals may interact with the touch sensitive display screen to select an emotion classification for an image in a multi-sensorial manner, e.g., by touching coordinates on a mood map projected at the back of an image with visual and/or audio accompaniment. The visual and audio accompaniment may vary in response to the user's selection to provide real time multi-sensorial response to the user. The initially assigned or aggregated emotion classification may be adjusted to integrate the user's selection.

Emotion classification may be initially assigned to photos based on sentiment analysis of caption, and when a caption is not available various matching techniques may be applied. For examples, matching techniques may include, but are not limited to, associations with other images by computer vision (such as association of a photo with other images with same or similar colors that were captioned and classified), and association based on time and place (such as association of a photo with other images taken/created in the same context (event, locale, and so forth) that were captioned and classified).

Visual and aural accompaniments may be provided by image regions. For example, as one moves an icon of the image around a projection of the mood map behind an image, the color of the mood map may change to reflect the different moods of the different regions or areas of the image. The mood map may, e.g., be grey when an area associated with low energy and negative mood is touched, v. pink when a positive, high energy area is touched. Additionally or alternatively, the interaction may be complemented aurally. Tonal feedback may be associated with different emotional states. When the user touches a specific spot (coordinates) on the mood map, an appropriate musical phrase may be played. The music may change as the user touches different places on the mood map. An extensive library of musical phrases (snippets) may be created/provided to be associated with 16 zones of the circumplex model of emotion.

By touching numerous images and/or selecting/adjusting their emotion classifications, individuals may create musical and visual compositions. The visual and aural association of images can convey the socio-emotionai dynamics (e.g., emotional contagion, entrainment, attunement). Longer visual sequences or musical phrases may be stringed together by touching different photos (that have been assigned emotion classifications by mood mapping or sentiment analysis of image caption). These longer phrases reflect the “mood wave” or collective mood of the images that have been selected. The music composition affordances in this system may be nearly infinite, with hundreds of millions of permutations possible. The result may be an engaging, rich exploration and composition space.

Resultantly, people of a community can compose jointly and build on one another's compositions. People can look back at the history of color and music that have been associated with a particular photograph. Together, their collective interactions may form/covey the socio-emotional dynamics of the community.

Further, the photos/pictures may be displayed based on a determined mood of the user. The user's mood may be determined, e.g., based on analysis of facial expression and/or other mood indicators of the user. The analysis may be performed on data captured via the individuals' phones (e.g., camera capture of expression or reading of pulse via light) or embedded camera on the large screen display. Thus, the individuals' emotions may guide the arrangement of photos/pictures displayed. By changing their expressions, the individuals may cause the arrangement and musical composition to be changed.

In embodiments, the system may also allow users to experiment with emotional contagion effects and other social dynamics. In response to user inputs, emotion tags and filters may be used to juxtapose a particular image with other images that have either a similar affect/mood, or with similar context and different affect/mood.

Further, images may be sorted by the various models of emotion (e.g., the circumplex model which is organized by the dimensions of arousal and valence, or a simple negative to positive arrangement).

Various aspects of illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

The terms “images,” “photos,” “pictures,” and their variants may be considered synonymous, unless the context of their usage clearly indicates otherwise.

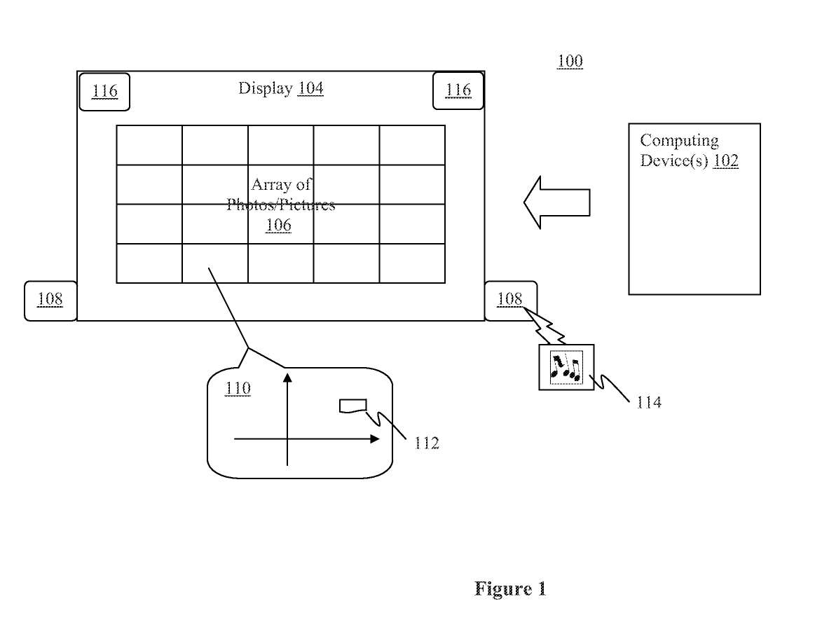

FIG. 1 illustrates an overview of an arrangement associated with multi-sensorial emotional expression, in accordance with various embodiments of the present disclosure. As illustrated, arrangement 100 may include one or more computing device(s) 102 and display device 104 coupled with each other. An array of photos/pictures 106 having associated emotion classifications may be displayed on display device 104, under control of computing device(s) 102 (e.g., by an application executing on computing device(s) 102). In response to a user selection of one of the photos/pictures, a mood map 110, e.g., a mood grid, including an icon 112 representative of the selected photo/picture may be displayed on display device 104, by computing device(s) 102, to enable the user to select an emotion classification for the photo/picture. In embodiments, the mood map may be provided with visual and/or audio accompaniment corresponding to an initial or current aggregate emotion classification of the selected photo/picture. In response to a user selection of an emotion classification, through, e.g., placement of icon 112 at a mood location on mood map 110, adjusted audio and/or visual responses reflective of the selected emotion classification may be provided. Further, the selected emotion classification may be aggregated with the initial or aggregated emotion classification, by computing device(s) 102.

In embodiments, arrangement 100 may include speakers 108 for providing the audio accompaniments/responses. Audio accompaniments/responses may include playing of a music snippet 114 representative of the selected or aggregated emotion classification. Visual accompaniments/responses may include changing the color of a boundary trim of the selected photo to correspond to the selected or aggregated emotion classification. As described earlier, the visual/audio accompaniments may also vary for different regions of a photo/picture, corresponding to different colors or other attributes of the regions of the photo/picture, as the user hovers/moves around different regions of the photo/picture.

In embodiments, mood map 110 may be two dimensional mood grid. Mood map 110 may be displayed on the back of the selected photo/picture. Mood map 110 may be presented through an animation of flipping the selected photo/picture. In embodiments, icon 112 may be a thumbnail of the selected photo/picture.

In embodiments, display device 104 may include a touch sensitive display screen. Selection of a photo/picture may be made by touching the photo/picture. Selection of the mood may be made by dragging and dropping icon 112.

In embodiments, arrangement 100 may be equipped to recognize user gestures. Display of next or previous set of photos/pictures may be commanded through user gestures. In embodiments, display device 104 may also include embedded cameras 116 to allow capturing of user's user gestures and/or facial expressions for analysis. The photos/pictures displayed may be a subset of photos/pictures of particular emotion classifications selected from a collection of photos/pictures based on a determination of the user's mood in accordance with a result of the facial expression analysis, e.g., photos/pictures with emotion classifications commensurate with the happy or more somber mood of the user, or the opposite, photos/pictures with emotion classifications to induce happier mood for users with somber mood. In alternate embodiments, arrangement 100 may include communication facilities to provide similar data, e.g., cameras or mobile phones of the users.

In embodiments, display device 104 may be a large display device, e.g., a wall size display device, allowing a wall of community photos/pictures of a community be displaced for individual and/or collective viewing and multisensory expression of mood.

In various embodiments, computing device(s) 102 may include one or more local and/or remote computing devices. In embodiments, computing device(s) 102 may include a local computing device coupled to one or more remote computing servers via one or more networks. The local computing device and the remote computing servers may be any one of such devices known in the art. The one or more networks may be one or more local or wide area, wired or wireless networks, including, e.g., the Internet.

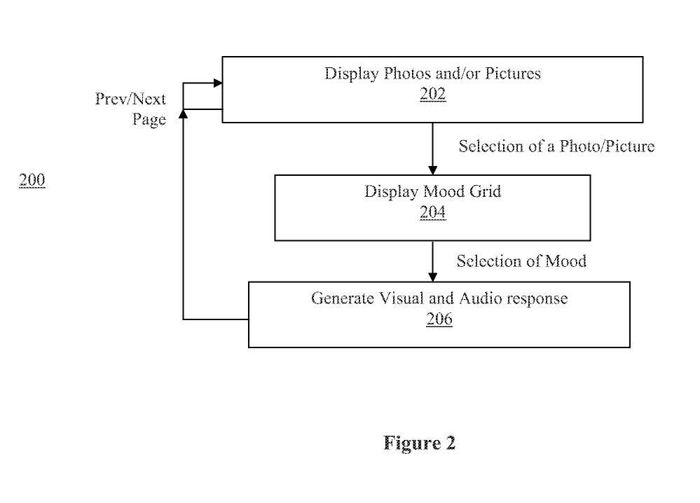

Referring now to FIG. 2, wherein a process for individually and/or jointly expressing emotion using arrangement 100 is illustrated, in accordance with various embodiments. As shown, process 200 may start at block 202 with a number of photos/pictures having associated emotion classifications, e.g., photos/pictures of a community, displayed on a large (e.g., wall size) touch sensitive display screen. The photos/pictures may be a subset of a larger collection of photos/pictures. The subset may be selected by a user or responsive to a result of a determination of the user's mood, e.g., based on a result of an analysis of the user's facial expression, using associated emotion classifications of the photos/pictures. Process 200 may remain at block 202 with additional display as a user pages back and forth (e.g., via paging gestures) of the displayed photos/pictures, or browsing through different subsets of the collection of different emotion classifications.

Prior and/or during the display, block 202 may also include the upload of photos/pictures by various users, e.g., from Instagram or other social media. The users may be of a particular community or association. Uploaded photos/pictures may be analyzed and assigned emotion classifications, by computing device(s) 102, based on sentiment analysis of captions of the photos/pictures. When captions are not available, various matching techniques may be applied. For examples, matching techniques may include, but are not limited to, associations with other images by computer vision (such as association of an image with other images with same or similar colors that were captioned and classified), and association based on time and place (such as association of an image with other images taken in the same context (event, locale, and so forth) that were captioned and classified).

From block 202, on selection of a photo/picture, process 200 may proceed to block 204. At block 204, a mood map, e.g., a mood grid, may be displayed by computing device(s) 102. As described earlier, in embodiments, the mood map may be displayed at the back of the selected photo/picture, and presented to the user, e.g., via an animation of flipping the selected photo/picture. Individuals may be allowed to adjust/correct the emotion classification of an image by touching the image, and moving an icon of the image to the desired spot on the “mood map”. In embodiments, the user's mood selection may be aggregated with other user's selection. From block 204, on selection of a mood, process 200 may proceed to block 206. At block 206, audio and/or visual responses corresponding to the selected or updated aggregated emotion classification may be provided.

As described earlier, in embodiments, tonal feedback may be associated with different emotional states. When the user touches a specific spot (coordinates) on the mood map, an appropriate musical phrase may be played. The music may change as the user touches different places on the mood map. An extensive library of musical phrases (snippets) may be created/provided to be associated with, e.g., 16 zones of the circumplex model of emotion. Visual response may also be provided. As one moves an icon of the image around a projection of the mood map behind the image, the color of the mood map may be changed to reflect the mood of the zone. For example, the mood map may be grey when an area associated with low energy and negative mood is touched, v. pink when a positive, high energy area is touched.

From block 206, process 200 may return to block 202, and continues therefrom.

Thus, by touching numerous images, users, individually or jointly may create musical and visual compositions. The visual and aural association of images can convey the socio-emotional dynamics (e.g., emotional contagion, entrainment, attunement). As the user successively touches different images on the projection (one or more at a time), and the photos/pictures including their visual and/or aural responses may be successively displayed/played or refreshed, providing a background swath of color represents the collective mood of the photos and the transition in mood across the photos. Further, compound or longer musical phrases may be formed by successively touching different photos (one or more at a time), that have been assigned a mood by mood mapping or sentiment analysis of image caption. These compound and/or longer phrases may also reflect the “mood wave” or collective mood of the images that have been selected. The music composition affordances in this system may be nearly infinite, with hundreds of millions of permutations possible. The result may be an engaging, rich exploration and composition space.

Resultantly, as earlier described, people of a community can compose jointly and build on one another's compositions. People can look back at the history of color and music that have been associated with a particular photograph. Together, their collective interactions may form/covey the socio-emotional dynamics of the community

In embodiments, at block 202, facial expression and/or other mood indicators may be analyzed. The analysis may be performed on data captured via the individuals' phones (e.g., camera capture of expression or reading of pulse via light) or embedded camera on the large screen display. The individuals' emotions may guide the selection and/or arrangement of the photos/pictures. By changing their expressions, the individuals may cause the arrangement (and musical composition to be changed).

In embodiments, at block 204, history of past mood selections by other users of the community (along with the associated audio and/or visual responses) may also be presented in response to a selection of a photo/picture.

Thus, the arrangement may allow users to experiment with emotional contagion effects and other social dynamics. In response to user inputs, emotion tags and filters may be used to juxtapose a particular image with other images that have either a similar effect, or with similar context and different effect.

Further, images may be sorted by the various models of emotion (e.g., the circumplex model which is organized by the dimensions of arousal and valence, or a simple negative to positive arrangement).

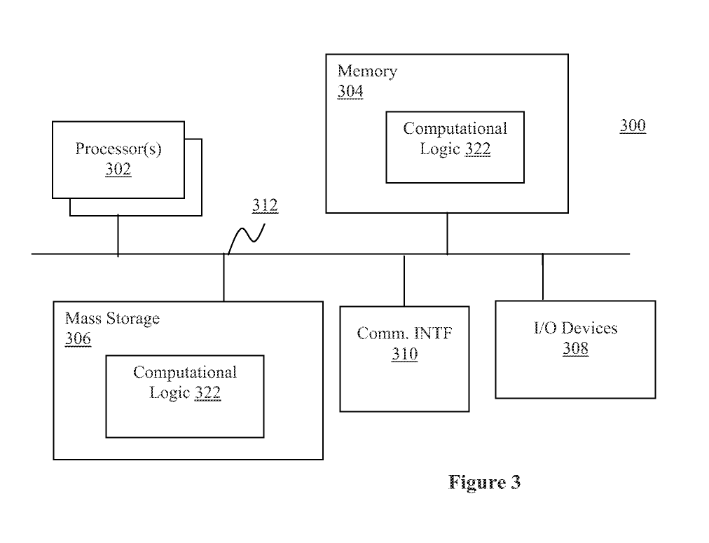

Referring now to FIG. 3, wherein an example computer suitable for use for the arrangement of FIG. 1, in accordance with various embodiments, is illustrated. As shown, computer 300 may include one or more processors or processor cores 302, and system memory 304. For the purpose of this application, including the claims, the terms “processor” and “processor cores” may be considered synonymous, unless the context clearly requires otherwise. Additionally, computer 300 may include mass storage devices 306 (such as diskette, hard drive, compact disc read only memory (CD-ROM) and so forth), input/output devices 308 (such as display, keyboard, cursor control and so forth) and communication interfaces 310 (such as network interface cards, modems and so forth). The elements may be coupled to each other via system bus 312, which may represent one or more buses. In the case of multiple buses, they may be bridged by one or more bus bridges (not shown).

Each of these elements may perform its conventional functions known in the art. In particular, system memory 304 and mass storage devices 306 may be employed to store a working copy and a permanent copy of the programming instructions implementing the multi sensory expression of emotion functions described earlier. The various elements may be implemented by assembler instructions supported by processors(s) 302 or high-level languages, such as, for example, C, that can be compiled into such instructions.

The permanent copy of the programming instructions may be placed into permanent storage devices 306 in the factory, or in the field, through, for example, a distribution medium (not shown), such as a compact disc (CD), or through communication interface 310 (from a distribution server (not shown)). That is, one or more distribution media having an implementation of the agent program may be employed to distribute the agent and program various computing devices.

The constitution of these elements 302-312 are known, and accordingly will not be further described.

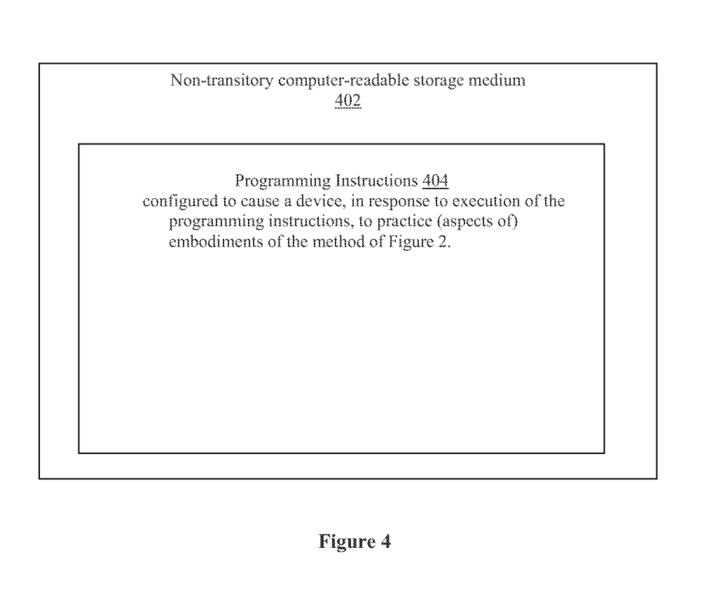

FIG. 4 illustrates an example non-transitory computer-readable storage medium having instructions configured to practice all or selected aspects of the method of FIG. 2; in accordance with various embodiments of the present disclosure. As illustrated, non-transitory computer-readable storage medium 402 may include a number of programming instructions 404. Programming instructions 404 may be configured to enable a device, e.g., computer 300, in response to execution of the programming instructions, to perform various operations of process 200 of FIG. 2, e.g., but not limited to, analysis of photos/pictures, assignment of emotion classifications to photos/pictures, display of photos/pictures, display of the mood grid, generation of audio and/or visual responses and so forth. In alternate embodiments, programming instructions 404 may be disposed on multiple non-transitory computer-readable storage media 402 instead.

Referring back to FIG. 3, for one embodiment, at least one of processors 302 may be packaged together with computational logic 322 configured to practice aspects of the method of FIG. 2. For one embodiment, at least one of processors 302 may be packaged together with computational logic 322 configured to practice aspects of the method of FIG. 2 to form a System in Package (SiP). For one embodiment, at least one of processors 302 may be integrated on the same die with computational logic 322 configured to practice aspects of the method of FIG. 2. For one embodiment, at least one of processors 302 may be packaged together with computational logic 322 configured to practice aspects of the method of FIG. 2 to form a System on Chip (SoC). For at least one embodiment, the SoC may be utilized in, e.g., but not limited to, a computing tablet.

<Directly corresponding plain English version of the claims to be inserted here after QR approval of the claims (by Intel Legal), prior to filing.>

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims.

What is claimed is:

1. At least one storage medium comprising a plurality of instructions configured to enable a computing device, in response to execution of the instructions by the computing device, to
display a plurality of images having associated emotion classifications on a display device accessible to a plurality of users; and
facilitate the plurality of users to individually and/or jointly modify the associated emotion classifications in a multi-sensorial manner.

2. The at least one storage medium of claim 1, wherein display a plurality of images having associated emotion classifications comprises display the plurality of images having associated emotion classifications on a touch sensitive display screen accessible to the plurality of users.

3. The at least one storage medium of claim 1, wherein facilitate the plurality of users to individually and/or jointly modify the associated emotion classifications comprises facilitate a user in selecting an emotion classification for one of the images.

4. The at least one storage medium of claim 3, wherein facilitate a user in selecting an emotion classification for one of the images comprises facilitating a user in interacting with a mood map to select an emotion classification for one of the images.

5. The at least one storage medium of claim 4, wherein facilitate a user in interacting with a mood map comprises facilitate display of the mood map in a manner that is visually reflective of an initial or an aggregated emotion classification of the one image.

6. The at least one storage medium of claim 5, wherein facilitate a user in interacting with a mood map further comprises facilitate output of audio that is aurally reflective of the initial or aggregated emotion classification of the one image to accompany the display of the mood map.

7. The at least one storage medium of claim 4, wherein facilitate a user in interacting with a mood map comprises update an initial or aggregated emotion classification of the one image in response to the user's selection of an emotion classification for the one image, including real time update of the display of the mood map, and companion audio, if provided, to reflect the updated aggregated emotion classification of the one image.

8. The at least one storage medium of claim 1, wherein display a plurality of images having associated emotion classifications comprises display a plurality of images having associated emotion classifications based on a determination of a user's mood in accordance with a result of an analysis of the user's facial expression.

9. The at least one storage medium of claim 1, wherein the instructions are further configured to enable the computing device, in response to execution of the instructions by the computing device, to analyze one of the images, and based at least in part on a result of the analysis, assign an initial emotion classification to the one image.

10. The at least one storage medium of claim 9, wherein analyze one of the image comprises analyze a caption of the one image.

11. The at least one storage medium of claim 9, wherein analyze one of the image comprises comparison of the one image against one or more other ones of the images with associated emotion classification, based on one or more visual or contextual properties of the images.

12. The at least one storage medium of claim 1, wherein display the plurality of images comprises sequentially display the plurality of images with visual attributes respectively reflective of aggregated emotion classification of the images to provide a mood wave.

13. The at least one storage medium of claim 12, wherein the instructions are further configured to enable the computing device, in response to execution of the instructions by the computing device, to output audio snippets that are respectively reflective of the aggregated emotion classifications of the images to accompany the sequential display of the images to provide the mood wave.

14. The at least one storage medium of claim 1, wherein the instructions are further configured to enable the computing device, in response to execution of the instructions by the computing device, to select the images from a collection of images, or a subset of the images, based at least in part on the emotion classifications of the images.

15. The at least one storage medium of claim 1, wherein the instructions are further configured to enable the computing device, in response to execution of the instructions by the computing device, to sort the images, based at least in part on the emotion classifications of the images.

16. A method for expressing emotion, comprising:
displaying a plurality of images having associated emotion classifications, by a computing device, on a display device accessible to a plurality of users; and
facilitating the plurality of users, by the computing device, to individually and/or jointly modify the emotion classifications of the images in a multi-sensorial manner, including facilitating a user in selecting an emotion classification for one of the images.

17. The method of claim 16, wherein facilitating a user in contributing in selecting an emotion classification for one of the images comprises facilitating the user, by the computing device, in interacting with a mood map to selecting an emotion classification for one of the images.

18. The method claim 17, wherein facilitating a user in interacting with a mood map comprises facilitating displaying of the mood map, by the computing device, in a manner that is visually reflective of an initial or an aggregated emotion classification of the one image; and facilitating output of audio, by the computing device, that is aurally reflective of the initial or aggregated emotion classification of the one image to accompany the displaying of the mood map.

19. The method of claim 17, wherein facilitating a user in interacting with a mood map further comprises facilitating update, by the computing device, of an aggregated emotion classification of the one image to include the user's selection of an emotion classification for the image, including real time updating of the mood map, and companion audio, if provided, by the computing device, to reflect the updated aggregated emotion classification of the one image.

20. The method of claim 17, wherein displaying a plurality of images having associated emotion classifications comprises displaying a plurality of images having associated emotion classifications based on a determination of a user's mood in accordance with a result of an analysis of the user's facial expression.

21. The method of claim 16, further comprising analyzing, by the computing device, one of the images, and based at least in part on a result of the analysis, assigning, by the computing device, an initial emotion classification to the one image, wherein analyzing includes comprises analyzing, by the computing device, a caption of the one image, or comparing, by the computing device, the one image against one or more other ones of the images with associated emotion classifications, based on one or more visual or contextual properties of the images.

22. The method of claim 16, wherein displaying the plurality of images comprises sequentially displaying, by the computing device, the plurality of images with visual attributes respectively reflective of aggregated emotion classifications of the images to provide a mood wave; and outputting audio snippets that are respectively reflective of the aggregated emotion classifications of the images to accompany the sequential displaying of the images to provide the mood wave.

23. The method of claim 16, further comprising selecting, by the computing device, the images from a collection of images, or a subset of the images, based at least in part on the emotion classifications of the images.

24. An apparatus for expressing emotions, comprising:
a display device configured to be accessible to a plurality of users; and
a computing device coupled with the display device, and having instructions configured, in response to execution, to:
display on the display device a plurality of images having associated emotion classifications; and
facilitate the plurality of users to individually and jointly modify the emotion classifications of the images in a multi-sensorial manner, wherein facilitate includes facilitates a user in selection of an emotion classification for one of the images, using a mood map;
wherein using a mood map, includes display of the mood map, in a manner that is visually reflective of an initial or an aggregated emotion classification of the one image; and
output of audio that is aurally reflective of the initial or aggregated emotion classification of the one image to accompany the display of the mood map.

25. The apparatus of claim 24, wherein display the plurality of images comprises sequentially display the plurality of images with visual attributes respectively reflective of aggregated emotion classification of the images to provide a mood wave; and output audio snippets that are respectively reflective of the aggregated emotion classification of the images to accompany the sequential display of the images to provide the mood wave.
